(19) United States
(12) Patent Application Publication
(10) Pub. No.: US 2024/0104957 A1
(43) Pub. Date: Mar. 28, 2024

(54) METHOD OF ACQUIRING EYE IMAGE, APPARATUS, DEVICE AND MEDIUM

(71) Applicant: Beijing Zitiao Network Technology Co., Ltd., Beijing (CN)

(72) Inventors: Jiu Xia, Beijing (CN); Guanghui Liu, Beijing (CN)

(21) Appl. No.: 18/462,998

(22) Filed: Sep. 7, 2023

(30) Foreign Application Priority Data
Sep. 22, 2022 (CN) 202211160918.3

(51) Int. Cl. G06V 40/18; G06V 10/141; H04N 23/11

(52) U.S. Cl. CPC G06V 40/193; G06V 10/141; H04N 23/11

(57) ABSTRACT

The present disclosure provides a method of acquiring an eye image, an apparatus, a device and a medium. The method includes: sending an image acquisition instruction to the first camera and the second camera, the image acquisition instruction including an acquisition time, and an acquisition time of the first camera and an acquisition time of the second camera being different; according to the acquisition time of the first camera, empowering at least one first infrared light source and controlling the first camera to acquire a first eye image; and according to the acquisition time of the second camera, empowering at least one second infrared light source and controlling the second camera to acquire a second eye image.

### CROSS-REFERENCE TO THE RELATED APPLICATION

The present application claims priority of Chinese Patent Application No. 202211160918.3, filed on Sep. 22, 2022, the disclosure of which is hereby incorporated herein by reference in its entirety as part of the present disclosure.

### TECHNICAL FIELD

Embodiments of the present disclosure relate to a method of acquiring an eye image, an apparatus, a device and a medium.

### BACKGROUND

With the development of eye tracking technology, the application of eye tracking technology to head-mounted display devices such as extended reality (XR) devices can enrich the interaction mode of head-mounted display devices, thus making human-computer interaction more direct, flexible, and convenient. Extended reality (XR) devices can generate a combination of real and virtual by computer technology and wearable devices, which is a human-computer interactive environment. Moreover, XR is a general term of multiple virtual technologies such as virtual reality (VR), augmented reality (AR), mix reality (MR), and so on.

### SUMMARY

The present disclosure provides a method of acquiring an eye image, an apparatus, a device and a medium.

In the first aspect, the embodiments of the present disclosure provide a method of acquiring an eye image, which comprises: sending an image acquisition instruction to a first camera and a second camera, where the image acquisition instruction comprises an acquisition time, and an acquisition time of the first camera and an acquisition time of the second camera are different; according to the acquisition time of the first camera, empowering at least one first infrared light source and controlling the first camera to acquire a first eye image; and according to the acquisition time of the second camera, empowering at least one second infrared light source and controlling the second camera to acquire a second eye image.

In the second aspect, the embodiments of the present disclosure provide an apparatus of acquiring an eye image, which comprises: an instruction sending module, used for sending an image acquisition instruction to a first camera and a second camera, where the image acquisition instruction comprises an acquisition time, and an acquisition time of the first camera and an acquisition time of the second camera are different; a first controlling module, used for empowering at least one first infrared light source and controlling the first camera to acquire a first eye image according to the acquisition time of the first camera; and a second controlling module, used for empowering at least one second infrared light source and controlling the second camera to acquire a second eye image according to the acquisition time of the second camera.

In the third aspect, the embodiments of the present disclosure provide an electronic device, which comprises: a processor and a memory. The memory is used for storing a computer program, and the processor is used for calling and running the computer program stored in the memory, so as to execute the method of acquiring the eye image described in the embodiments of the first aspect.

In the fourth aspect, the embodiments of the present disclosure provide a computer-readable storage medium, which is used for storing a computer program. The computer program enables a computer to execute the method of acquiring the eye image described in the embodiments of the first aspect.

In the fifth aspect, the embodiments of the present disclosure provide a computer program product comprising a program instruction. When the program instruction runs in an electronic device, the program instruction enables the electronic device to execute the method of acquiring the eye image described in the embodiments of the first aspect.

### BRIEF DESCRIPTION OF THE DRAWINGS

To explain the technical scheme of the embodiments of the present disclosure more clearly, the drawings used in the description of the embodiments will be briefly described in the following. It is obvious that the drawings described below are only related to some embodiments of the present disclosure. For ordinary skilled person in the art, other drawings can be obtained according to these drawings without creative labor.

FIG. 1 is a schematic flow diagram of a method of acquiring an eye image provided by the embodiments of the present disclosure;

FIG. 2A is a schematic diagram of arranging the camera on the lens cone provided by the embodiments of the present disclosure;

FIG. 2B is another schematic diagram of arranging the camera on the lens cone provided by the embodiments of the present disclosure;

FIG. 2C is a schematic diagram of arranging the infrared light sources on the lens cone provided by the embodiments of the present disclosure;

FIG. 3 is a schematic flow diagram of another method of acquiring an eye image provided by the embodiments of the present disclosure;

FIG. 4 is a schematic diagram of sending image acquisition instructions to cameras in parallel and controlling cameras to execute eye image acquisition operation provided by the embodiments of the present disclosure;

FIG. 5 is a schematic flow diagram of still another method of acquiring an eye image provided by the embodiments of the present disclosure;

FIG. 6 is a schematic diagram of sending image acquisition instructions to cameras respectively and controlling cameras to execute eye image acquisition operation provided by the embodiments of the present disclosure;

FIG. 7 is a schematic block diagram of an apparatus of acquiring an eye image provided by the embodiments of the present disclosure; and

FIG. 8 is a schematic block diagram of an electronic device provided by the embodiments of the present disclosure.

### DETAILED DESCRIPTION

The technical scheme in the embodiments of the present disclosure will be clearly and completely described in combination with the drawings related to the embodiments of the present disclosure. Apparently, the embodiments described are only part of the embodiments of the present disclosure, not all the embodiments. Based on the embodiments of the present disclosure, all other embodiments obtained by ordinary skilled person in the art without creative labor shall fall within the scope of protection of the present disclosure.

It should be noted that the terms “first”, “second”, etc. in the description and claims of the present disclosure and in the drawings above are used to distinguish similar objects and are not necessarily used to describe a specific order or sequence. It should be understood that used data is interchangeable where appropriate, so that embodiments of the present disclosure described herein can be implemented in an order other than those illustrated or described herein. In addition, the terms “comprising” and “having”, and any variations thereof, are intended to cover non-exclusive inclusion, for example, a process, method, system, product or server comprising a series of steps or units, should not be limited to those clearly listed steps or units, but may include other steps or units that are not clearly listed or inherent to the process, method, product, or device.

When the head-mounted display device with eye tracking function performs human-computer interaction, the user's eye image is generally obtained based on the cooperation of infrared light source and camera, and then the human-computer interaction is carried out based on the eye movement data determined by the eye image. The present disclosure is applicable to human-computer interaction using a head-mounted display device with eye tracking function. Due to the mutual influence of the infrared light emitted by the infrared light sources on the left and right lens cones of the head-mounted display device, there is an error in the eye image captured by the camera. For example, there are light spots in the left eye image and these light spots are formed by the infrared light source on the lens cone corresponding to the right eye. Moreover, there are light spots in the right eye image and these light spots are formed by the infrared light source on the lens cone corresponding to the left eye. This leads to poor interaction effect and other defects in human-computer interaction based on the eye movement data determined by the eye image. Therefore, aiming at this problem, the present disclosure provides a method of acquiring an eye image, which can obtain eye images with high accuracy, so as to provide conditions for improving human-computer interaction. The present disclosure provides a method of acquiring an eye image, an apparatus, a device and a medium, which improves the accuracy of acquiring eye images and provides conditions for improving human-computer interaction effect.

The technical solution disclosed by the embodiments of the present disclosure has at least the following beneficial effects. By sending image acquisition instructions to the first camera and second camera, the first infrared light source is empowered according to the acquisition time of the first camera in the image acquisition instruction, and the first camera is controlled to acquire a first eye image, and according to the acquisition time of the second camera, the second infrared light source is empowered and the second camera is controlled to acquire a second eye image. The acquisition time of the first camera is different from the acquisition time of the second camera. Therefore, by controlling the first infrared light source corresponding to the first camera and the second infrared light source corresponding to the second camera to be empowered at different time, as well as controlling the first or second camera to acquire users' eye images when the first or second infrared light source is in illumination state, the image acquisition time of the first camera and the image acquisition time of the second camera are staggered, and the empowering time of the first infrared light source and the empowering time of the second infrared light source are also staggered, so as to avoid the problem of eye image errors between eye images acquired by the first camera and the second camera caused by mutual interference of infrared light when simultaneously empowering the first and second infrared light sources, thereby improving the accuracy of acquiring eye image and providing conditions for improving human-machine interaction effects.

In order to facilitate the understanding of the embodiments of the present disclosure, before describing respective embodiments of the present disclosure, some concepts involved in all embodiments of the present disclosure are properly explained as follows.

1) Virtual reality (VR) is a technology for creating and experiencing virtual worlds, which calculates and generates a virtual environment. Virtual reality is multi-source information (the virtual reality mentioned in the present disclosure includes at least visual perception, as well as auditory perception, tactile perception, motion perception, and even taste perception, olfactory perception, etc.), which achieves the fusion of virtual environments, interactive 3D dynamic scenes, and simulation of physical behavior, thereby enabling users to immerse themselves in simulated virtual reality environments and implementing applications in various virtual environments such as maps, games, videos, education, healthcare, simulation, collaborative training, sales, manufacturing assistance, maintenance, repair, and so on.

2) Virtual reality devices (VR devices) are terminals that achieve virtual reality effects, which can usually be provided in the form of glasses, head mount display (HMD), or contact lenses for visual perception and other forms of perception. Of course, the implemented forms of virtual reality devices are not limited to this, and can be further miniaturized or enlarged as needed.

Optionally, the virtual reality devices recorded in the embodiments of the present disclosure may include, but are not limited to, the following types.

2.1) Computer based virtual reality (PCVR) devices, using the PC to perform related calculations and data output for virtual reality functions, while external computer based virtual reality devices use the data output from the PC to achieve virtual reality effects.

2.2) Mobile virtual reality devices, supporting setting up mobile terminals (such as smartphones) in various ways (such as head worn displays with dedicated card slots), through wired or wireless connections with the mobile terminal, the mobile terminal performs virtual reality related calculations and outputs data to the mobile virtual reality device, such as watching virtual reality videos through the mobile terminal's APP.

2.3) All-in-one virtual reality device, having a processor for computing related virtual functions, thus having independent virtual reality input and output functions, without the need to connect to a PC or mobile terminal, and with high degrees of freedom of use.

3) Augmented reality (AR): a technology that calculates the camera's pose parameters in the real world (also known as the 3D world or real world) in real-time during the process of capturing images by the camera, and adds virtual elements to the images captured by the camera based on the camera pose parameters. Virtual elements include but are not limited to: images, videos, and 3D models. The goal of AR technology is to connect the virtual world onto the real world for interaction on the screen.

4) Mixed reality (MR): a simulated set that integrates sensory inputs created by computers (such as virtual objects) with sensory inputs or representations from physical settings. In some MR sets, the sensory inputs created by computers can adapt to changes in sensory inputs from physical settings. In addition, some electronic systems used to present MR scenes can monitor the orientation and/or position relative to the physical scene, thereby enabling virtual objects to interact with real objects (i.e., physical elements or their representations from the physical scene). For example, the system can monitor motion, thus making virtual plants appear stationary relative to physical buildings.

5) Extended reality (XR) refers to all the real and virtual combined environments and human-machine interactions generated by computer technology and wearable devices, including various forms such as virtual reality (VR), augmented reality (AR), and mixed reality (MR).

After introducing some concepts involved in the embodiments of the present disclosure, the following will provide a detailed description of a method of acquiring an eye image provided by the embodiments of the present disclosure in combination with the attached drawings.

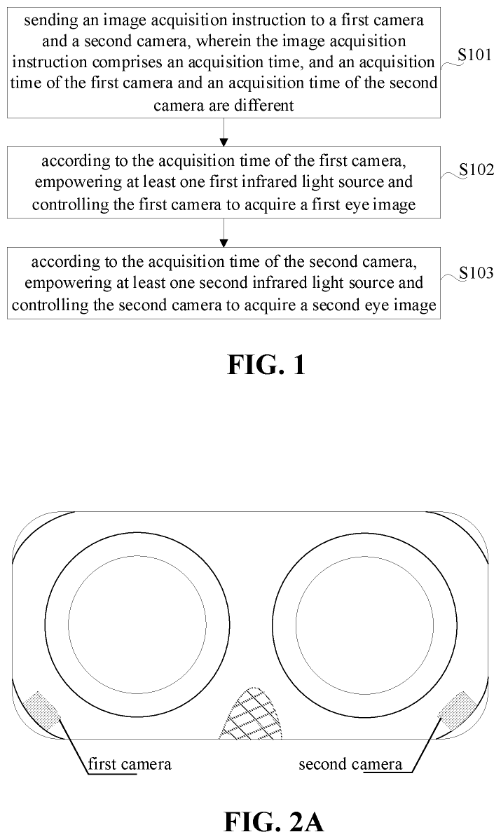

FIG. 1 is a schematic flow diagram of a method of acquiring an eye image provided by the embodiments of the present disclosure. The embodiments of the present disclosure can be applied to obtaining eye image scenes with high accuracy. The method of acquiring the eye image can be executed by an apparatus of acquiring the eye image, so as to control the acquisition process of the eye image. The apparatus of acquiring the eye image can be composed of hardware and/or software, and can be integrated into electronic devices.

The electronic devices can be any hardware device with eye tracking function. In this embodiment, the electronic device is preferably a head-mounted display device, and the head-mounted display device is optionally an XR device. The XR device can be a VR device, AR device, or MR device, etc.

As illustrated in FIG. 1, the method of acquiring the eye image includes the following steps.

S101, sending an image acquisition instruction to a first camera and a second camera, where the image acquisition instruction comprises an acquisition time, and an acquisition time of the first camera and an acquisition time of the second camera are different.

S102, according to the acquisition time of the first camera, empowering at least one first infrared light source and controlling the first camera to acquire a first eye image.

S103, according to the acquisition time of the second camera, empowering at least one second infrared light source and controlling the second camera to acquire a second eye image.

In this embodiment, the first camera and the second cameras are preferably infrared cameras, so as to acquire infrared light emitted by infrared light sources.

The first infrared light source and the second infrared light source are preferably infrared radiation (IR) lamps.

The first infrared light source corresponds to the first camera, and the second infrared light source corresponds to the second camera. Moreover, the number of the first infrared light source and the number of the second infrared light source are multiple, e.g., at least two, respectively.

Considering that the electronic device has two lens cones, namely the left lens cone and the right lens cone, in this embodiment, the first camera and the second camera can be respectively arranged on one lens cone of the electronic device, so as to acquire the user's left eye image and right eye image.

Optional arrangements for the first camera and second camera include the following mode.

Mode 1

The first camera is arranged on the first lens cone, and the second camera is arranged on the second lens cone.

Mode 2

The first camera is arranged on the second lens cone, and the second camera is arranged on the first lens cone.

The first lens cone is the left lens cone, and the second lens cone is the right lens cone; or, the first lens cone is the right lens cone, and the second lens cone is the left lens cone, which is not specifically limited here.

In the embodiments of the present disclosure, the deployment position of the camera on the lens cone is determined based on the position of the camera where it can fully capture the entire eye area.

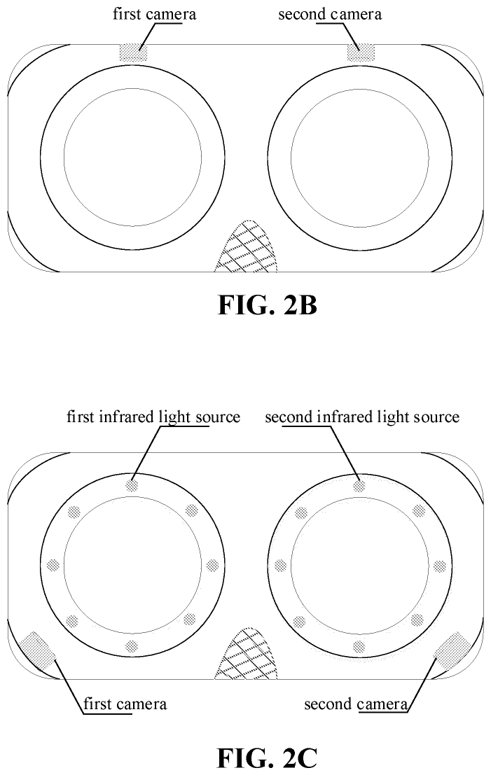

For example, if the first camera can capture the entire left eye area in the case where the first camera is arranged at the bottom left corner of the left lens cone and the second camera can capture the entire right eye area in the case where the second camera is arranged at the bottom right corner of the right lens cone, then the first camera is arranged at the bottom left corner of the left lens cone, and the second camera is arranged at the bottom right corner of the right lens cone, as illustrated in FIG. 2A.

For another example, as illustrated in FIG. 2B, if the first camera can capture the entire left eye area in the case where the first camera is arranged in the middle of the upper frame of the left lens cone and the second camera can capture the entire right eye area in the case where the second camera is arranged in the middle of the upper frame of the right lens cone, then the first camera is arranged in the middle of the upper frame of the left lens cone, and the second camera is arranged in the middle of the upper frame of the right lens cone, and so on.

In addition, in the embodiments of the present disclosure, a plurality of first infrared light sources corresponding to the first camera and a plurality of second infrared light sources corresponding to the second camera can be respectively arranged around the lens cone where the corresponding camera is located.

Optionally, the arrangements of the first infrared light sources and the second infrared light sources may include the following situations.

Situation 1

In the case where the first camera is arranged on the first lens cone and the second camera is arranged on the second lens cone, a plurality of first infrared light sources are uniformly arranged around the first lens cone, and a plurality of second infrared light sources are uniformly arranged around the second lens cone.

Situation 2

In the case where the first camera is arranged on the second lens cone and the second camera is arranged on the first lens cone, a plurality of first infrared light sources are uniformly arranged around the second lens cone, and a plurality of second infrared light sources are uniformly arranged around the first lens cone.

For example, if the first camera is arranged in the lower left corner of the left lens cone and the second camera is arranged in the lower right corner of the right lens cone, then the plurality of first infrared light sources are uniformly arranged around the left lens cone and the plurality of second infrared light sources are uniformly arranged around the right lens cone, as illustrated in FIG. 2C.

In actual use, when users use electronic devices with eye tracking function, the electronic device not only controls the display screen to display image information, but also needs to control the cameras arranged on the left and right lens cones to acquire eye images of the user in real time, and needs to determine the user's eye movement data based on the eye images acquired by the cameras. Then, human-machine interaction operations are performed based on eye movement data.

At present, when the electronic device controls the cameras on the left and right lens cones to acquire user eye images, it controls the cameras on the left and right lens cones and the plurality of infrared light sources to be in operation simultaneously, so that the camera on the left lens cone captures the left eye image when the infrared light from the infrared light source shines on the user's left eye, and the camera on the right lens captures the right eye image when the infrared light from the infrared light source shines on the user's right eye. However, considering that the infrared light sources on the left and right lens cones of the electronic device are in working state (luminance state) at the same time, the infrared light emitted by the infrared light sources on the left and right lens cones will interfere with each other, resulting in a spot in the eye image acquired by the corresponding camera which is formed by the infrared light emitted by the infrared light sources on another lens cone, thereby resulting in errors in the acquired eye image. Furthermore, when performing human-computer interaction based on the eye movement data determined by the eye image, there are problems such as poor interaction effects.

Aiming at the above problems, in the present disclosure, the working time of the cameras on the left and right lens cones and multiple infrared light sources of the electronic device is staggered, so as to avoid the mutual interference of infrared light emitted by the infrared light sources on the left and right lens cones when the camera and multiple infrared light sources are working at the same time, which results in errors in the acquired eye images and poor human-computer interaction effects.

Specifically, while the electronic device controls the display screen to display image information, it sends image acquisition instructions with different acquisition times to the first and second cameras through the main controller such as the central processing unit, so that the first and second cameras can stagger the acquisition time of user eye images based on the different acquisition times carried by the image acquisition instruction. Here, the acquisition time means the moment at which the acquisition is performed, or it means the above moment as well as the duration of the acquiring operation, or it means the duration of the time during which the acquisition is performed. The embodiments of the present disclosure do not limit this, as long as the working time of the cameras and the plurality of infrared light sources on the left and right lens cones of the electronic device can be staggered, and the cameras and the plurality of infrared light sources on the left and right lens cones can be avoided from working simultaneously. The acquisition time is adaptively set according to actual needs, and there are no specific restrictions on it here. For example, the image acquisition time of the first camera is t₁, the image acquisition time of the second camera is t₂, and t₁<t₂.

After the first and second cameras receive the above image acquisition instructions, they analyze the image acquisition instructions respectively to obtain the different acquisition times carried in the image acquisition instructions. Then, the first camera and the second camera determine their own acquisition time from obtained different acquisition times based on their own identification information.

In this embodiment, the identification information of the camera refers to the information that uniquely identifies the camera, such as the camera name, camera serial number, camera number, or the like.

For example, assuming that the identification information of the first camera is camera 1 and the identification information of the second camera is camera 2, then the first camera can obtain the acquisition time corresponding to identification information of camera 1 from the image acquisition instruction, and the second camera can obtain the acquisition time corresponding to identification information of camera 2 from the image acquisition instruction. If the acquisition time corresponding to camera 1 is time X1, and the acquisition time corresponding to camera 2 is time X2, then the acquisition time of the first camera is time X1, and the acquisition time of the second camera is time X2.

Furthermore, the first camera determines whether the current time is its own image acquisition time. If so, the corresponding first infrared light source is controlled to be empowered based on its own acquisition time. At the same time, when the first infrared light source is on, the user's first eye image is acquired. Otherwise, it remains in standby state.

Similarly, the second camera determines whether the current time is its own image acquisition time. If so, the corresponding second infrared light source is controlled to be empowered based on its own acquisition time. At the same time, when the second infrared light source is on, the user's second eye image is acquired. Otherwise, it remains in standby state.

As an alternative implementation method, considering that the first camera, second camera, first infrared light source corresponding to the first camera, and second infrared light source corresponding to the second camera in the present disclosure, these devices can also be electrically connected to the control module. Specifically, the output terminal of the first camera and the output terminal of the second camera are electrically connected to the input terminal of the control module; and the output terminals of the control module are electrically connected to the first infrared light source and the second infrared light source, respectively. Therefore, after the first and second cameras acquire their respective acquisition times, the first and second cameras can also send their respective acquisition times, as well as the infrared light source identification corresponding to their own identification information, to the control module. Furthermore, after receiving the information sent by the first and second cameras, the control module controls the first infrared light source corresponding to the first camera and the second infrared light source corresponding to the second camera to be empowered at different acquisition times based on the received acquisition time and infrared light source identification, so as to avoid the interference between the first infrared light source and the second infrared light source when the first infrared light source and the second infrared light source are empowered simultaneously.

The identification of the infrared light source refers to information that can uniquely determine the identity of the infrared light source, such as the infrared light source label. For example, if the identification information of the camera is camera 1, then the infrared light source identification corresponding to camera 1 can be selected as infrared light source 1; if the identification information of the camera is camera A, then the infrared light source identification corresponding to camera A can be selected as infrared light source A, and so on.

In the embodiments of the present disclosure, the control module refers to any processor device other than the main controller, such as chips with controlling and data processing functions like the micro control unit (MCU), or microcontroller, which are not specifically limited here.

That is, when the first camera determines that the current time is its own image acquisition time and the control module determines that the current time is the empowering time of the first infrared light source, the control module can control the empowering of the first infrared light source. At the same time, when the first infrared light source is in the empowering state, the first camera correspondingly performs an eye image acquisition operation to acquire the first eye image.

Similarly, when the second camera determines that the current time is its own image acquisition time and the control module determines that the current time is the empowering time of the second infrared light source, the control module can control the empowering of the second infrared light source. At the same time, when the second infrared light source is in the empowering state, the second camera correspondingly performs an eye image acquisition operation to capture the second eye image.

It should be noted that in this embodiment, if the first camera and the first infrared light source are located on the left lens cone, and the second camera and the second infrared light source are located on the right lens cone, the first eye image acquired by the first camera is the eye image of the user's left eye (left eye image), and the second eye image acquired by the second camera is the eye image of the user's right eye (right eye image).

If the first camera and the first infrared light source are located on the right lens cone, and the second camera and the second infrared light source are located on the left lens cone, the first eye image acquired by the first camera is the eye image of the user's right eye (right eye image), and the second eye image acquired by the second camera is the eye image of the user's left eye (left eye image).

It should be noted that when controlling the display screen to display screen information in the present disclosure, different display methods can be adopted based on the electronic device type. For example, the left and right display screens can be controlled to synchronously display the same screen information according to the preset frame rate, or the left and right display screens can also be controlled to display screen information in parity frame manner.

The preset frame rate can be adaptively set based on the screen refresh performance of electronic devices. For example, the preset frame rate can be set to 90 frames per second (fps), or 120 fps, etc. There are no specific limitation on it here.

In the embodiments of the present disclosure, controlling the display of image information on the left and right display screens in a parity frame manner can refer to: the left display screen displays odd frame images, and the right display screen displays even frame images; or, the left display screen displays even frame images, and the right display screen displays odd frame images.

Optionally, when the display screen displays screen information in a parity frame manner, the acquisition time of the first camera and the acquisition time of the second camera in this embodiment can be determined based on the parity frame screen displayed on the corresponding display screen, which can include the following modes.

In the first mode, if the first camera corresponds to the left display screen and the second camera corresponds to the right display screen, and when the left display screen displays odd frame images and the right display screen displays even frame images, the time corresponding to odd frame images can be determined as the acquisition time of the first camera, and the time corresponding to even frame images can be determined as the acquisition time of the second camera.

In the second mode, if the first camera corresponds to the left display screen and the second camera corresponds to the right display screen, and when the left display screen displays even frames and the right display screen displays odd frames, the time corresponding to even frames can be determined as the acquisition time of the first camera, and the time corresponding to odd frames can be determined as the acquisition time of the second camera.

In the third mode, if the first camera corresponds to the right display screen and the second camera corresponds to the left display screen, and when the right display screen displays odd frame images and the left display screen displays even frame images, the time corresponding to odd frame images can be determined as the acquisition time of the first camera, and the time corresponding to even frame images can be determined as the acquisition time of the second camera.

In the fourth mode, if the first camera corresponds to the right display screen and the second camera corresponds to the left display screen, and when the right display screen displays even frames and the left display screen displays odd frames, the time corresponding to even frames can be determined as the acquisition time of the first camera, and the time corresponding to odd frames can be determined as the acquisition time of the second camera.

It should be noted that the execution order of S102 and S103 in this embodiment can be as follows: S102 is executed first, and then S103 is executed; or, S103 is executed first and then S102 is executed, with the specific execution sequence determined by the acquisition time of the first camera and the acquisition time of the second camera.

For example, if the acquisition time of the first camera precedes the acquisition time of the second camera, S102 is executed first and then S103 is executed; otherwise, S103 is executed first and then S102 is executed.

It can be understood that in the embodiments of the present disclosure, by sending image acquisition instructions with different acquisition times to the cameras on the left and right lenses, the cameras on the left and right lens cones control the corresponding infrared light source to emit infrared lights to the user's eyes according to their respective acquisition times, and acquire eye images of infrared light spots formed on the user's eyes, so as to control the operation of the cameras and infrared light sources on the left and right lens cones at different times, i.e., to stagger the working time, so that the acquired left eye image is not affected by the interference of infrared light emitted by the infrared light source located on the right lens cone, and similarly, the right eye image is not affected by the interference of infrared light emitted by the infrared light source located on the left lens cone, thereby improving the accuracy of eye image acquisition.

In the method of acquiring eye images provided by the present disclosure, by sending an image acquisition instruction to a first camera and a second camera, the first infrared light source is empowered according to the acquisition time of the first camera, and the first camera is controlled to acquire a first eye image, and the second infrared light source is empowered according to the acquisition time of the second camera, and the second camera is controlled to acquire a second eye image. The acquisition time of the first camera is different form the acquisition time of the second camera. Therefore, by controlling the first infrared light source corresponding to the first camera and the second infrared light source corresponding to the second camera to be empowered at different times, as well as controlling the first or second camera to acquire user eye images when the first or second infrared light sources are in an empowering state, the image acquisition time of the first and second cameras are staggered, and the empowering time of the first infrared light source and the empowering time of the second infrared light source are also staggered, so as to avoid the problem of eye image errors between the eye images acquired by the first camera and the second camera caused by the interference of infrared light when the first infrared light source and the second infrared light source are empowered simultaneously, thereby improving the accuracy of eye image acquisition and providing conditions for improving human-machine interaction effects.

It can be known from the above description that in the present disclosure, high-precision eye images are acquired by staggering the working time of the cameras and infrared light sources on the left and right lens cones, thereby improving the human-computer interaction effect based on this high-precision eye image when performing the human-computer interaction.

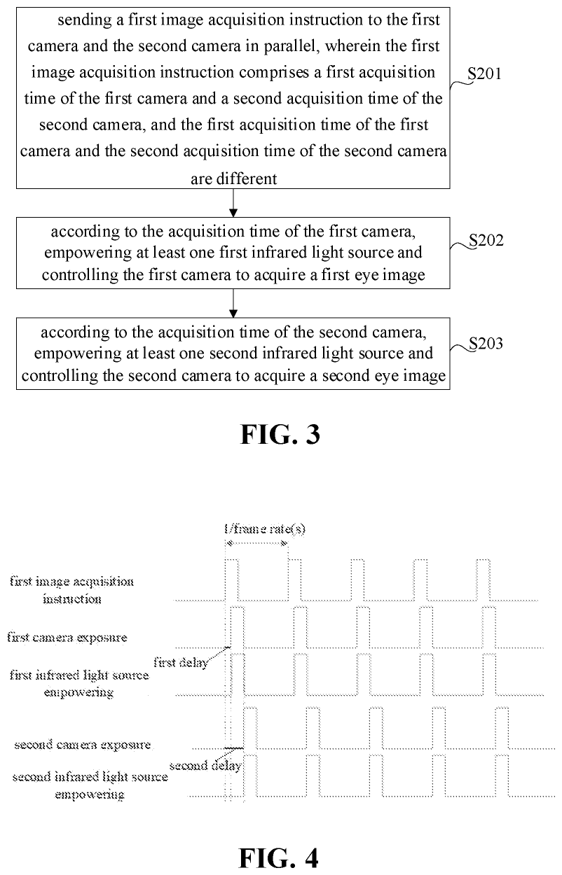

Based on the above embodiments, the present disclosure further optimizes the operation of sending image acquisition instructions to the first and second cameras. The following is a specific explanation of the optimization process described in the embodiment of the present disclosure, combined with FIG. 3.

As illustrated in FIG. 3, the method of acquiring an eye image includes the following steps.

S201, sending a first image acquisition instruction to the first camera and the second camera in parallel.

The first image acquisition instruction comprises a first acquisition time of the first camera and a second acquisition time of the second camera, and the first acquisition time of the first camera is different from the second acquisition time of the second camera.

S202, according to the first acquisition time of the first camera, empowering at least one first infrared light source and controlling the first camera to acquire a first eye image.

S203, according to the second acquisition time of the second camera, empowering at least one second infrared light source and controlling the second camera to acquire a second eye image.

The first acquisition time precedes the second acquisition time, or the first acquisition time can be after the second acquisition time. Specific settings can be made according to actual needs, and there will be no specific limitation here.

As an example, the electronic device can send the same image acquisition instruction (the first image acquisition instruction) to the first camera and the second camera in parallel through the main controller such as the central processing unit while displaying image information, and the first image acquisition instruction carries the first acquisition time of the first camera and the second acquisition time of the second camera. Thus, when the first and second cameras receive the first image acquisition instruction, they analyze the first image acquisition instruction to obtain the first acquisition time corresponding to the first camera and the second acquisition time corresponding to the second camera.

When the first and second cameras acquire their respective image acquisition times, they can acquire their respective acquisition times from the parsed first image acquisition instruction based on their own identification information.

Furthermore, in the present disclosure, a similar or identical implementation method as described above is adopted, the first infrared light source is empowered based on the first acquisition time of the first camera, and the first camera is controlled to acquire the first eye image; and according to the second acquisition time of the second camera, the second infrared light source is empowered and the second camera is controlled to acquire the second eye image.

It should be noted that the execution order of S202 and S203 in this embodiment can be that: S202 is executed first, and then S203 is executed; or, S203 is executed first and then S202 is executed. The specific execution sequence is determined by the order of the first acquisition time of the first camera and the second acquisition time of the second camera.

For example, if the first acquisition time of the first camera precedes the second acquisition time of the second camera, the S202 is executed first and then S203 is executed; otherwise, S203 is executed first and then S202 is executed.

To clearly illustrate this embodiment, the following takes FIG. 4 as an example to illustrate the operation of sending the first image acquisition instruction to the first camera and second camera in parallel.

As illustrated in FIG. 4, the electronic device sends a first image acquisition instruction to the first camera and second camera, the first image acquisition instruction carries the first acquisition time of the first camera and the second acquisition time of the second camera, and the first acquisition time precedes the second acquisition time. The first acquisition time and the second acquisition time are specifically illustrated as the first delay situation and second delay situation of the first image acquisition instruction in FIG. 4.

Then, according to the first acquisition time carried by the first image acquisition instruction, the first camera controls the first infrared light source to be empowered and acquire the first eye image. After the first camera acquires the first eye image, the first camera controls the first infrared light source to be extinguished. Then, according to the second acquisition time carried by the second image acquisition instruction, the second camera controls the second infrared light source to be empowered and acquire the second eye image. After the second camera acquires the second eye image, the second camera controls the second infrared light source to be extinguished. Then, the operations are repeated that the first camera controls the first infrared light source to be empowered according to the first acquisition time and acquires the first eye image and the second camera controls the second infrared light source to be empowered according to the second acquisition time and acquires the second eye image until the user stops using the electronic device.

In the method of acquiring eye images provided by the present disclosure, by sending an image acquisition instruction to a first camera and a second camera, the first infrared light source is empowered and the first camera is controlled to acquire a first eye image according to the acquisition time of the first camera, and the second infrared light source is empowered and the second camera is controlled to acquire a second eye image according to the acquisition time of the second camera. The acquisition time of the first camera and the acquisition time of the second camera are different. Therefore, by controlling the first infrared light source corresponding to the first camera and the second infrared light source corresponding to the second camera to be empowered at different times, as well as controlling the first or second camera to acquire user eye images when the first or second infrared light sources are in an empowering state, the image acquisition time of the first and second cameras are staggered, and the empowering time of the first infrared light source and the second infrared light source are also staggered, so as to avoid the problem of eye image errors between the eye images acquired by the first camera and the second camera caused by the interference of infrared light when the first infrared light source and the second infrared light source are empowered simultaneously, thereby improving the accuracy of eye image acquisition and providing conditions for improving human-machine interaction effects.

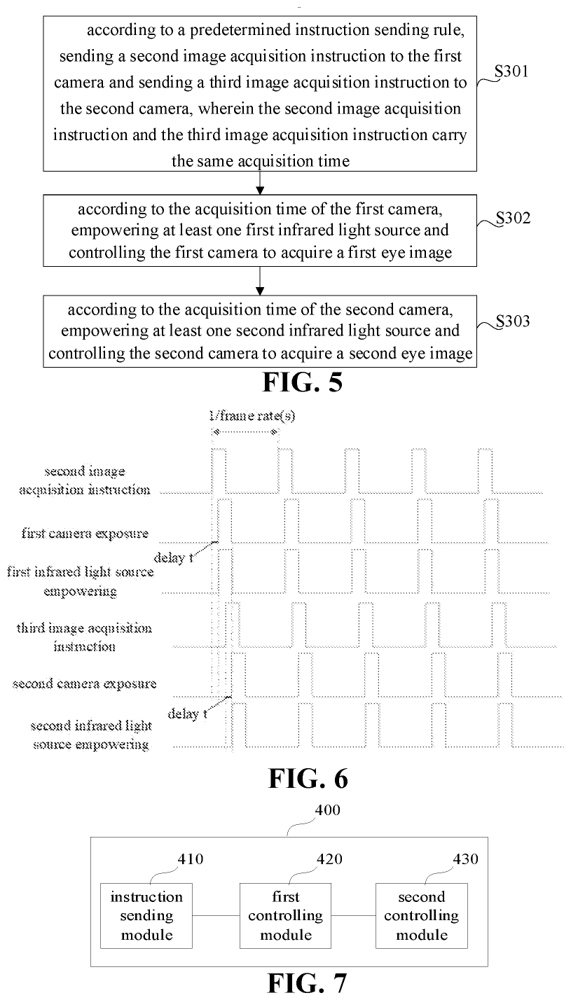

Based on the above embodiments, the embodiment of present disclosure can also optimize the operation of sending the image acquisition instructions to the first and second cameras. The following is a specific explanation of the optimization process described in the embodiment of the present disclosure, combined with FIG. 5.

As illustrated in FIG. 5, the method of acquiring the eye image includes the following steps.

S301, according to a predetermined instruction sending rule, sending a second image acquisition instruction to the first camera and sending a third image acquisition instruction to the second camera.

The second image acquisition instruction and the third image acquisition instruction carry the same acquisition time.

S302, according to the acquisition time of the first camera, empowering at least one first infrared light source and controlling the first camera to acquire a first eye image.

S303, according to the acquisition time of the second camera, empowering at least one second infrared light source and controlling the second camera to acquire a second eye image.

The predetermined instruction sending rule can be any instruction sending method, and can be adaptively set according to actual needs.

Exemplary, the predetermined instruction sending rule may include the following situations.

Situation 1

The second image acquisition instruction is sent to the first camera at a first moment; and the third image acquisition instruction is sent to the second camera at a second moment.

Situation 2

The second image acquisition instruction is sent to the first camera at the second moment; and the third image acquisition instruction is sent to the second camera at the first moment.

The first moment is before the second moment.

As an example, in this embodiment, by sending different image acquisition instructions (the second image acquisition instruction and the third image acquisition instruction) with the same acquisition time to the first camera and the second camera through the main controller such as CPU at different times, the first infrared light source are sequentially empowered and the first camera is controlled to acquire the first eye image, and then the second infrared light source are empowered and the second camera is controlled to acquire the second eye image, according to the time sequence of the received image acquisition instructions.

In specific implementation, when the first camera first receives the second image acquisition instruction, and then the second camera receives the third image acquisition instruction, at first, the second image acquisition instruction is parsed by the first camera to acquire the acquisition time corresponding to the first camera. Furthermore, when the first camera determines that the current time is its own image acquisition time, the first infrared light source is controlled to be empowered, and the first camera is controlled to acquire the first eye image when the first infrared light source is on. Afterwards, the second camera parses the third image acquisition instruction, so as to obtain the acquisition time corresponding to the second camera. Furthermore, when the second camera determines that the current time is its own image acquisition time, the second infrared light source is controlled to be empowered and the second camera is controlled to acquire the second eye image.

Alternatively, when the second camera first receives the third image acquisition instruction, and then the first camera receives the second image acquisition instruction, at first, the third image acquisition instruction is parsed by the second camera to obtain the acquisition time corresponding to the second camera. Furthermore, when the second camera determines that the current time is its own image acquisition time, the second infrared light source is controlled to be empowered, and the second camera is controlled to acquire the second eye image. Afterwards, the second image acquisition instruction is parsed by the first camera to obtain the acquisition time corresponding to the first camera. Furthermore, when the first camera determines that the current time is its own image acquisition time, the first infrared light source is controlled to be empowered, and the first camera is controlled to acquire the first eye image.

That is to say, the execution order of S302 and S303 in this embodiment may be that: S302 is executed first, and then S303 is executed; or, S303 is executed first, and then S302 is executed. The specific execution order is determined based on the order of the first camera receiving the second image acquisition instruction and the second camera receiving the third image acquisition instruction.

To clearly illustrate this embodiment, the following takes FIG. 6 as an example to illustrate the operation of sending a second image acquisition instruction to the first camera and sending a third image acquisition instruction to the second camera according to a predetermined instruction sending rule.

As illustrated in FIG. 6, the electronic device sends a second image acquisition instruction to the first camera, and sends a third image acquisition instruction to the second camera. The second image acquisition instruction and the third image acquisition instruction carry the same acquisition time, which is specifically illustrated as the delay tin FIG. 6.

When the first camera receives the second image acquisition instruction at the first moment T1, the second camera receives the third image acquisition instruction at the second moment T2, and T1 is before T2, according to the acquisition time carried in the second image acquisition instruction, the first camera controls the empowering of the first infrared light source, and acquires the first eye image. After the first camera finishes acquiring the first eye image, the first camera controls the first infrared light source to be turned off. Then, according to the acquisition time carried in the third image acquisition instruction, the second camera controls the empowering of the second infrared light source, and acquires the second eye image. After the second camera finishes acquiring the second eye image, the second camera controls the second infrared light source to be turned off. Then, the operations are repeated that the first camera controls the empowering of the first infrared light source and acquires the first eye image according to the acquisition time carried in the second image acquisition instruction and the second camera controls the empowering of second infrared light source and acquires the second eye image according to the acquisition time carried in the third image acquisition instruction, until the user stops using the electronic device.

In the method of acquiring eye images provided by the present disclosure, by sending an image acquisition instruction to a first camera and a second camera, the first infrared light source is empowered and the first camera is controlled to acquire a first eye image according to the acquisition time of the first camera, and the second infrared light source is empowered and the second camera is controlled to acquire a second eye image according to the acquisition time of the second camera. The acquisition time of the first camera is different from the acquisition time of the second camera. Therefore, by controlling the first infrared light source corresponding to the first camera and the second infrared light source corresponding to the second camera to be empowered at different times, as well as controlling the first or second camera to acquire user eye images when the first or second infrared light sources are in an empowering state, the image acquisition time of the first camera and the image acquisition time of the second camera are staggered, and the empowering time of the first infrared light source and the empowering time of the second infrared light source are also staggered, so as to avoid the problem of eye image errors between the eye images acquired by the first camera and the second camera caused by the interference of infrared light when the first infrared light source and the second infrared light source are empowered simultaneously, thereby improving the accuracy of eye image acquisition and providing conditions for improving human-machine interaction effects.

Referring to FIG. 7, an apparatus of acquiring an eye image provided by the embodiments of the present disclosure is described. FIG. 7 is a schematic block diagram of an apparatus of acquiring an eye image provided by an embodiment of the present disclosure.

The apparatus of acquiring the eye image 400 includes: an instruction sending module 410, a first controlling module 420, and a second controlling module 430.

The instruction sending module 410 is used for sending an image acquisition instruction to a first camera and a second camera. The image acquisition instruction comprises an acquisition time, and the acquisition time of the first camera and the acquisition time of the second camera are different.

The first controlling module 420 is used for empowering at least one first infrared light source and controlling the first camera to acquire a first eye image, according to the acquisition time of the first camera.

The second controlling module 430 is used for empowering at least one second infrared light source and controlling the second camera to acquire a second eye image, according to the acquisition time of the second camera.

In an optional implementation of the embodiment of present disclosure, the instruction sending module 410 is specifically used for: sending a first image acquisition instruction to the first camera and the second camera in parallel.

The first image acquisition instruction comprises a first acquisition time of the first camera and a second acquisition time of the second camera, and the first acquisition time of the first camera is different from the second acquisition time of the second camera.

In an optional implementation of the embodiment of present disclosure, the instruction sending module 410 is specifically used for: according to a predetermined instruction sending rule, sending a second image acquisition instruction to the first camera and sending a third image acquisition instruction to the second camera.

The second image acquisition instruction and the third image acquisition instruction carry the same acquisition time.

In an optional implementation of the embodiment of the present disclosure, the predetermined instruction sending rule includes: sending the second image acquisition instruction to the first camera at a first moment, and sending the third image acquisition instruction to the second camera at a second moment; or, sending the second image acquisition instruction to the first camera at the second moment, and sending the third image acquisition instruction to the second camera at the first moment. The first moment is before the second moment.

In an optional implementation of the embodiment of the present disclosure, the first camera is arranged on a first lens cone, and the second camera is arranged on a second lens cone; or, the first camera is arranged on the second lens cone, and the second camera is arranged on the first lens cone.

In an optional implementation of the embodiment of the present disclosure, the first lens cone is a left lens cone, and the second lens cone is a right lens cone; or, the first lens cone is a right lens cone, and the second lens cone is a left lens cone.

In an optional implementation of the embodiment of the present disclosure, the at least one first infrared light source comprise a plurality of first infrared light sources, and the plurality of first infrared light sources are arranged around the first lens cone uniformly; or, the at least one second infrared light source comprise a plurality of second infrared light sources, and the plurality of second infrared light sources are arranged around the second lens cone uniformly.

In the apparatus of acquiring eye images provided by the present disclosure, by sending an image acquisition instruction to a first camera and a second camera, the first infrared light source is empowered and the first camera is controlled to acquire a first eye image according to the acquisition time of the first camera, and the second infrared light source is empowered and the second camera is controlled to acquire a second eye image according to the acquisition time of the second camera. The acquisition time of the first camera and the acquisition time of the second camera are different. Therefore, by controlling the first infrared light source corresponding to the first camera and the second infrared light source corresponding to the second camera to be empowered at different times, as well as controlling the first or second camera to acquire user eye images when the first or second infrared light sources are in an empowering state, the image acquisition time of the first camera and the image acquisition time of the second camera are staggered, and the empowering time of the first infrared light source and the empowering time of the second infrared light source are also staggered, so as to avoid the problem of eye image errors between the eye images acquired by the first camera and the second camera caused by the interference of infrared light when the first infrared light source and the second infrared light source are empowered simultaneously, thereby improving the accuracy of eye image acquisition and providing conditions for improving human-machine interaction effects.

It should be understood that the apparatus embodiment and the method embodiment may correspond to each other, and similar descriptions may be referred to the method embodiment. To avoid repetition, details are not repeated here. Specifically, the apparatus 400 illustrated in FIG. 7 can execute the method embodiment corresponding to FIG. 1, and the foregoing and other operations and/or functions of each module in the apparatus 400 respectively realizes corresponding processes in each method in FIG. 1, and for brevity, details are not repeated here.

The apparatus 400 in the embodiment of the present disclosure is described above from the perspective of functional modules with reference to the accompanying drawings. It should be understood that the functional modules may be implemented in the form of hardware, may also be implemented by instructions in the form of software, and may also be implemented by a combination of hardware and software modules. Specifically, each step of the method embodiment in the embodiment of the present disclosure can be completed by an integrated logic circuit of hardware in the processor and/or instructions in the form of software, and the steps of the method disclosed in the embodiment of the present disclosure can be directly represented as execution by a hardware decoding processor, or by the combination of hardware and software modules in the decoding processor. Optionally, the software module may be in a mature storage medium in this field such as random-access memory, flash memory, read-only memory, programmable read-only memory, electrically erasable programmable memory, and registers. The storage medium is in the memory, and the processor reads the information in the memory, and completes the steps in the above method embodiments in combination with its hardware.

It should be noted that the apparatus of acquiring the eye image 400 is not limited to include the various modules described above, and may also include more modules to achieve more comprehensive functions. For example, the instruction sending module 410, the first controlling module 420 and the second controlling module 430 may be hardware, software, firmware and any feasible combination of them. For example, the instruction sending module 410, the first controlling module 420 and the second controlling module 430 may be dedicated or general-purpose circuits, chips or devices, or may be a combination of a processor and a memory. Embodiments of the present disclosure do not limit the specific implementation forms of the instruction sending module 410, the first controlling module 420 and the second controlling module 430.

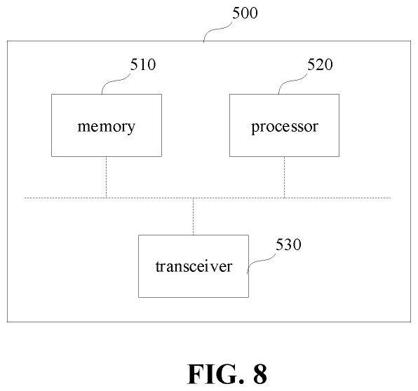

FIG. 8 is a schematic block diagram of an electronic device provided by an embodiment of the present disclosure. In this embodiment of the present disclosure, the electronic device may be any hardware device with an eye-tracking function. In this embodiment, the electronic device is preferably a head-mounted display device, and the head-mounted display device may optionally be an XR device. The XR device may be a VR device, an AR device, or an MR device.

As illustrated in FIG. 8, the electronic device 500 may include: a memory 510 and a processor 520.

The memory 510 is used to store computer programs and transmit the program codes to the processor 520. In other words, the processor 520 can invoke and run a computer program from the memory 510, so as to realize the method of acquiring an eye image in the embodiment of the present disclosure.

For example, the processor 520 can be used to execute the above embodiment of the method of acquiring the eye image according to the instructions in the computer program.

In some embodiments of the present disclosure, the processor 520 may include but not limited to: general-purpose processor, digital signal processor (DSP), application specific integrated circuit (ASIC), field programmable gate array (FPGA) or other programmable logic devices, discrete gates or transistor logic devices, discrete hardware components, and so on.

In some embodiments of the present disclosure, the processor 510 may include but not limited to: volatile memory and/or non-volatile memory. The non-volatile memory can be read-only memory (ROM), programmable read-only memory (PROM), erasable programmable read-only memory (EPROM), electrically programmable erase programmable read-only memory (EEPROM) or flash. The volatile memory may be random access memory (RAM), which is used as an external cache. By way of illustration and not limitation, many forms of RAM are available such as static RAM (SRAM), dynamic RAM (DRAM), synchronous DRAM (SDRAM), double data rate synchronous dynamic random access memory (DDR SDRAM), enhanced synchronous dynamic random access memory (ESDRAM), synch link dynamic random access memory (SLDRAM) and direct Rambus random access memory (DR RAM).

In some embodiments of the present disclosure, the computer program can be divided into one or more modules, and the one or more modules are stored in the memory 510, and executed by the processor 520 to complete the method of acquiring the eye image provided by the embodiments of the present disclosure. The one or more modules may be a series of computer program instruction segments capable of accomplishing specific functions, and the instruction segments are used to describe the execution process of the computer program in the electronic device.

As illustrated in FIG. 8, the electronic device may also include: a transceiver 530, which can be connected to the processor 520 or the memory 510.

The processor 520 can control the transceiver 530 to communicate with other devices, specifically, can send information or data to other devices, or receive information or data sent by other devices. The transceiver 530 may include a transmitter and a receiver. The transceiver 530 may further include antennas, and the number of antennas may be one or more.

It should be understood that the various components in the electronic device are connected through a bus system. The bus system includes not only a data bus, but also a power bus, a control bus and a status signal bus.

The present disclosure also provides a computer storage medium, on which a computer program is stored. When the computer program is executed by a computer, the computer can execute the method of acquiring the eye image of the above method embodiment.

The embodiment of the present disclosure also provides a computer program product including instructions, which cause the computer to execute the method of acquiring the eye image of the method embodiment above when executed by the computer.

When implemented using software, it may be implemented in whole or in part in the form of a computer program product. The computer program product includes one or more computer instructions. When the computer program instructions are loaded and executed on the computer, the processes or functions according to the embodiments of the present disclosure will be generated in whole or in part. The computer can be a general-purpose computer, a special purpose computer, a computer network, or other programmable device. The computer instructions may be stored in the computer-readable storage medium, or may be transmitted from one computer-readable storage medium to another computer-readable storage medium, for example, the computer instructions may be transferred from a website, computer, server, or data center by wire (such as coaxial cable, optical fiber, digital subscriber line (DSL)) or wireless (such as infrared, wireless, microwave, etc.) to another website site, computer, server or data center. The computer-readable storage medium may be any available medium that can be accessed by a computer, or a data storage device such as a server or a data center integrated with one or more available media. The available medium may be a magnetic medium (such as a floppy disk, a hard disk, or a magnetic tape), an optical medium (such as a digital video disc (DVD)), or a semiconductor medium (such as a solid-state disk (SSD)), etc.

Those skilled in the art can appreciate that the modules and algorithm steps of the examples described in conjunction with the embodiments disclosed herein can be implemented by electronic hardware, or a combination of computer software and electronic hardware. Whether these functions are executed by hardware or software depends on the specific application and design constraints of the technical solution. Skilled artisans may use different methods to implement the described functions for each specific application, but such implementation should not be regarded as exceeding the scope of the present disclosure.

In several embodiments provided in the present disclosure, it should be understood that the disclosed systems, devices and methods may be implemented in other ways. For example, the device embodiments described above are only illustrative. For example, the division of the modules is only a logical function division. In actual implementation, there may be other division methods. For example, multiple modules or components can be combined or can be integrate into another system, or some features may be ignored, or not implemented. In another point, the mutual coupling or direct coupling or communication connection shown or discussed may be through some interfaces, and the indirect coupling or communication connection of devices or modules may be in electrical, mechanical or other forms.

Modules described as separate components may be or may not be physically separated, and a component displayed as a module may be or may not be a physical module, that is, it may be in one place, or may also be distributed to multiple network units. Part or all the modules can be selected according to actual needs to achieve the purpose of the solution of the embodiments. For example, respective functional modules in respective embodiments of the present disclosure may be integrated into one processing module, or each module may exist separately physically, or two or more modules may be integrated into one module.

The above is only a specific implementation of the present disclosure, but the scope of protection of the present disclosure is not limited thereto. Anyone familiar with this technical field can easily think of changes or substitutions within the technical scope disclosed by the disclosure, should be covered within the protection scope of the present disclosure. Therefore, the protection scope of the present disclosure should be based on the protection scope of the claims.

1. A method of acquiring an eye image, comprising:
sending an image acquisition instruction to a first camera and a second camera, wherein the image acquisition instruction comprises an acquisition time, and an acquisition time of the first camera and an acquisition time of the second camera are different;
according to the acquisition time of the first camera, empowering at least one first infrared light source and controlling the first camera to acquire a first eye image; and
according to the acquisition time of the second camera, empowering at least one second infrared light source and controlling the second camera to acquire a second eye image.

2. The method of claim 1, wherein sending the image acquisition instruction to the first camera and the second camera comprises:
sending a first image acquisition instruction to the first camera and the second camera in parallel,
wherein the first image acquisition instruction comprises a first acquisition time of the first camera and a second acquisition time of the second camera, and the first acquisition time of the first camera and the second acquisition time of the second camera are different.

3. The method of claim 1, wherein sending the image acquisition instruction to the first camera and the second camera comprises:
according to a predetermined instruction sending rule, sending a second image acquisition instruction to the first camera and sending a third image acquisition instruction to the second camera,
wherein the second image acquisition instruction and the third image acquisition instruction carry the same acquisition time.

4. The method of claim 3, wherein the predetermined instruction sending rule comprises:
sending the second image acquisition instruction to the first camera at a first moment, and
sending the third image acquisition instruction to the second camera at a second moment; or,
sending the second image acquisition instruction to the first camera at the second moment, and
sending the third image acquisition instruction to the second camera at the first moment,
wherein the first moment precedes the second moment.

5. The method of claim 1, wherein the first camera is arranged on a first lens cone, and
the second camera is arranged on a second lens cone;
or,
the first camera is arranged on the second lens cone, and the second camera is arranged on the first lens cone.

6. The method of claim 5, wherein the first lens cone is a left lens cone, and the second lens cone is a right lens cone;
or,
the first lens cone is the right lens cone, and the second lens cone is the left lens cone.

7. The method of claim 5, wherein the at least one first infrared light source comprise a plurality of first infrared light sources, and the plurality of first infrared light sources are arranged around the first lens cone uniformly; or
the at least one second infrared light source comprise a plurality of second infrared light sources, and the plurality of second infrared light sources are arranged around the second lens cone uniformly.

8. An apparatus of acquiring an eye image, comprising:
an instruction sending module, used for sending an image acquisition instruction to a first camera and a second camera, wherein the image acquisition instruction comprises an acquisition time, and an acquisition time of the first camera and an acquisition time of the second camera are different;
a first controlling module, used for empowering at least one first infrared light source and controlling the first camera to acquire a first eye image according to the acquisition time of the first camera; and
a second controlling module, used for empowering at least one second infrared light source and controlling the second camera to acquire a second eye image according to the acquisition time of the second camera.

9. An electronic device, comprising:
a processor and a memory, wherein the memory is used for storing a computer program, and the processor is used for calling and running the computer program stored in the memory, so as to execute a method of acquiring an eye image,
wherein the method of acquiring the eye image comprises:
sending an image acquisition instruction to a first camera and a second camera, wherein the image acquisition instruction comprises an acquisition time, and an acquisition time of the first camera and an acquisition time of the second camera are different;
according to the acquisition time of the first camera, empowering at least one first infrared light source and controlling the first camera to acquire a first eye image; and
according to the acquisition time of the second camera, empowering at least one second infrared light source and controlling the second camera to acquire a second eye image.

10. A computer-readable storage medium, used for storing a computer program, wherein the computer program enables a computer to execute the method of acquiring the eye image according to claim 1.

11. A computer program product comprising a program instruction, wherein when the program instruction runs in an electronic device, the program instruction enables the electronic device to execute the method of acquiring the eye image according to claim 1.

12. The method of claim 2, wherein the first camera is arranged on a first lens cone, and the second camera is arranged on a second lens cone;
or,
the first camera is arranged on the second lens cone, and the second camera is arranged on the first lens cone.

13. The method of claim 3, wherein the first camera is arranged on a first lens cone, and the second camera is arranged on a second lens cone;
or,
the first camera is arranged on the second lens cone, and the second camera is arranged on the first lens cone.

14. The method of claim 4, wherein the first camera is arranged on a first lens cone, and the second camera is arranged on a second lens cone;
or,
the first camera is arranged on the second lens cone, and the second camera is arranged on the first lens cone.

15. The method of claim 12, wherein the at least one first infrared light source comprise a plurality of first infrared light sources, and the plurality of first infrared light sources are arranged around the first lens cone uniformly; or
the at least one second infrared light source comprise a plurality of second infrared light sources, and the plurality of second infrared light sources are arranged around the second lens cone uniformly.

16. The method of claim 13, wherein the at least one first infrared light source comprise a plurality of first infrared light sources, and the plurality of first infrared light sources are arranged around the first lens cone uniformly; or
the at least one second infrared light source comprise a plurality of second infrared light sources, and the plurality of second infrared light sources are arranged around the second lens cone uniformly.

17. The method of claim 14, wherein the at least one first infrared light source comprise a plurality of first infrared light sources, and the plurality of first infrared light sources are arranged around the first lens cone uniformly; or
the at least one second infrared light source comprise a plurality of second infrared light sources, and the plurality of second infrared light sources are arranged around the second lens cone uniformly.

18. The method of claim 12, wherein the first lens cone is a left lens cone, and the second lens cone is a right lens cone;
or,
the first lens cone is the right lens cone, and the second lens cone is the left lens cone.

19. The method of claim 13, wherein the first lens cone is a left lens cone, and the second lens cone is a right lens cone;
or,
the first lens cone is the right lens cone, and the second lens cone is the left lens cone.

20. The method of claim 14, wherein the first lens cone is a left lens cone, and the second lens cone is a right lens cone;
or,
the first lens cone is the right lens cone, and the second lens cone is the left lens cone.
